(19) United States
(12) Patent Application Publication
(10) Pub. No.: US 2024/0149834 A1
(43) Pub. Date: May 9, 2024

(54) VEHICLE FLUID CLEANING ASSEMBLY

(71) Applicant: Ford Global Technologies, LLC, Dearborn, MI (US)

(72) Inventors: Venkatesh Krishnan, Canton, MI (US); Sivaprasad Karnati, Chennai (IN); T Hariharan, Senthangudi (IN); Raghuraman Surineedi, Dearborn, MI (US); Ashwin Arunmozhi, Canton, MI (US); Rashaun Phinisee, Ypsilanti, MI (US); Kunal Singh, Farmington Hills, MI (US)

(73) Assignee: Ford Global Technologies, LLC, Dearborn, MI (US)

(21) Appl. No.: 18/052,956

(22) Filed: Nov. 7, 2022

(51) Int. Cl. B60S 1/50; B60S 1/56

(52) U.S. Cl. CPC B60S 1/50; B60S 1/56

(57) ABSTRACT

An assembly includes a fluid reservoir having a fluid outlet. The assembly includes a piston slidably supported in the fluid reservoir. The assembly includes a spring urging the piston toward an end of the fluid reservoir. The piston and the fluid reservoir define a working chamber in fluid communication with the fluid outlet. The assembly includes a nozzle in fluid communication with the working chamber via the fluid outlet. The assembly includes a valve between the nozzle and the fluid outlet.

### BACKGROUND

The Society of Automotive Engineers (SAE) has defined multiple levels of autonomous vehicle operation. At levels 0-2, a human driver monitors or controls the majority of the driving tasks, often with no help from the vehicle. For example, at level 0 (“no automation”), a human driver is responsible for all vehicle operations. At level 1 (“driver assistance”), the vehicle sometimes assists with steering, acceleration, or braking, but the driver is still responsible for the vast majority of the vehicle control. At level 2 (“partial automation”), the vehicle can control steering, acceleration, and braking under certain circumstances without human interaction. At levels 3-5, the vehicle assumes more driving-related tasks. At level 3 (“conditional automation”), the vehicle can handle steering, acceleration, and braking under certain circumstances, as well as monitoring of the driving environment. Level 3 requires the driver to intervene occasionally, however. At level 4 (“high automation”), the vehicle can handle the same tasks as at level 3 but without relying on the driver to intervene in certain driving modes. At level 5 (“full automation”), the vehicle can handle almost all tasks without any driver intervention. Vehicles, such as autonomous or semi-autonomous vehicles, typically include a variety of sensors. Some sensors detect internal states of the vehicle, for example, wheel speed, wheel orientation, and engine and transmission variables. Some sensors detect the position or orientation of the vehicle, for example, global positioning system (GPS) sensors; accelerometers such as piezo-electric or microelectromechanical systems (MEMS); gyroscopes such as rate, ring laser, or fiber-optic gyroscopes; inertial measurements units (IMU); and magnetometers. Some sensors detect the external world, for example, radar sensors, scanning laser range finders, light detection and ranging (LIDAR) devices, and image processing sensors such as cameras. A LIDAR device detects distances to objects by emitting laser pulses and measuring the time of flight for the pulse to travel to the object and back. Some sensors are communications devices, for example, vehicle-to-infrastructure (V2I) or vehicle-to-vehicle (V2V) devices. Sensor operation can be affected by obstructions, e.g., dust, snow, insects, etc.

### BRIEF DESCRIPTION OF THE DRAWINGS

FIG. 1 is a perspective view of a vehicle having a fluid cleaning assembly.

FIG. 2 is a perspective view of the fluid cleaning assembly with a piston at a top position.

FIG. 3 is a perspective view of the fluid cleaning assembly with the piston at a bottom position.

FIG. 4 a fluid schematic of the fluid cleaning assembly.

FIG. 5 is a block diagram of components of the vehicle.

### DETAILED DESCRIPTION

An assembly includes a fluid reservoir having a fluid outlet. The assembly includes a piston slidably supported in the fluid reservoir. The assembly includes a spring urging the piston toward an end of the fluid reservoir. The piston and the fluid reservoir define a working chamber in fluid communication with the fluid outlet. The assembly includes a nozzle in fluid communication with the working chamber via the fluid outlet. The assembly includes a valve between the nozzle and the fluid outlet.

The assembly may include a check valve between the fluid outlet and the valve, the check valve oriented to permit fluid flow from the working chamber to the valve, and to inhibit fluid flow from the valve to the working chamber.

The assembly may include a linear actuator connected to the piston and configured to move the piston away from the end of the fluid reservoir.

The assembly may include a sensor configured to detect a position of the piston relative to the fluid reservoir.

The fluid reservoir may include a fluid inlet in fluid communication with the working chamber.

The assembly may include a check valve connected to the fluid inlet and oriented to permit fluid flow into the working chamber via the fluid inlet and to inhibit fluid flow out of the working chamber via the fluid inlet.

The assembly may include a fill port in fluid communication with the fluid inlet.

The assembly may be free of a second fluid reservoir between the fluid reservoir and the fill port.

The assembly may include a second nozzle in fluid communication with the working chamber via the fluid outlet and a second valve between the second nozzle and the fluid outlet.

The assembly may include a fluid rail between the fluid outlet and the valve and second valve.

The assembly may include a stopper in the working chamber between the end of the fluid reservoir and the piston.

The spring may be in the fluid reservoir.

The spring may be compressed between the piston and a second end of the fluid reservoir opposite the end.

The assembly may include a rod fixed to the piston and extending outside the fluid reservoir.

The spring may surround the rod.

The assembly may include a vehicle sensor, the nozzle pointed at the vehicle sensor.

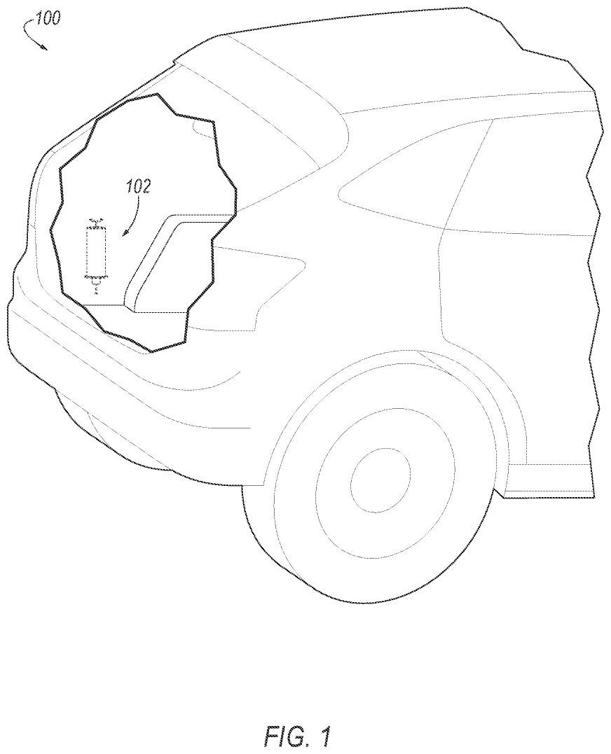

With reference to FIGS. 1-4, wherein like numerals indicate like parts throughout the several views, a vehicle 100 includes a fluid cleaning assembly 102. The fluid cleaning assembly 102 includes a fluid reservoir 104 having a fluid outlet 106 and a piston 108 slidably supported in the fluid reservoir 104. The fluid cleaning assembly 102 includes a spring 110 urging the piston 108 toward a first end 112 of the fluid reservoir 104. The piston 108 and the fluid reservoir 104 define a working chamber 114 in fluid communication with the fluid outlet 106. The fluid cleaning assembly 102 includes a nozzle 116 in fluid communication with the working chamber 114 via the fluid outlet 106. The fluid cleaning assembly 102 includes a valve 118 between the nozzle 116 and the fluid outlet 106.

The piston 108 and the spring 110 of the fluid cleaning assembly 102 provide quicker and more consistent fluid pressure to the nozzle 116, e.g., compared to conventional fluid cleaning assemblies. For example, the piston 108, urged by the spring 110, pressurizes fluid (such as liquid washer fluid that may include methanol, ethylene glycol, water, etc.) in the working chamber 114 which is provided to the nozzle 116 upon actuation of the valve 118, e.g., without needing to wait for a pump motor to spool up and pressurize the fluid.

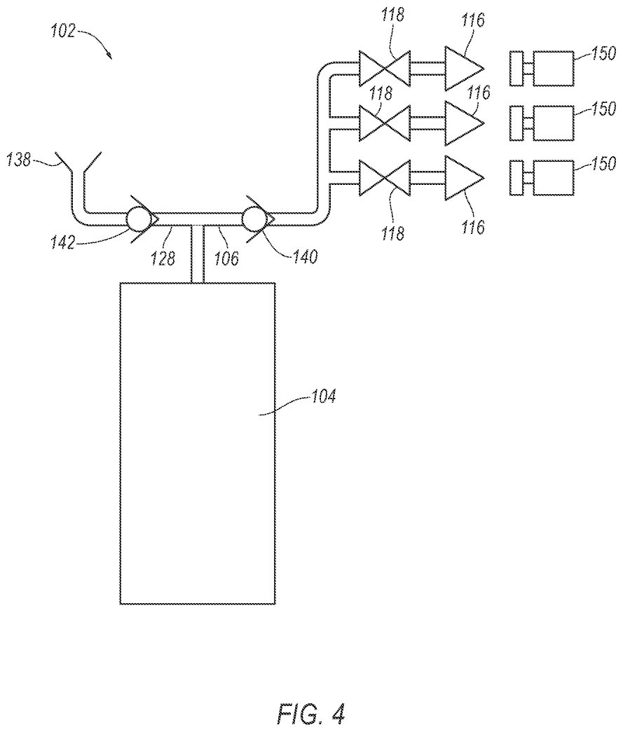

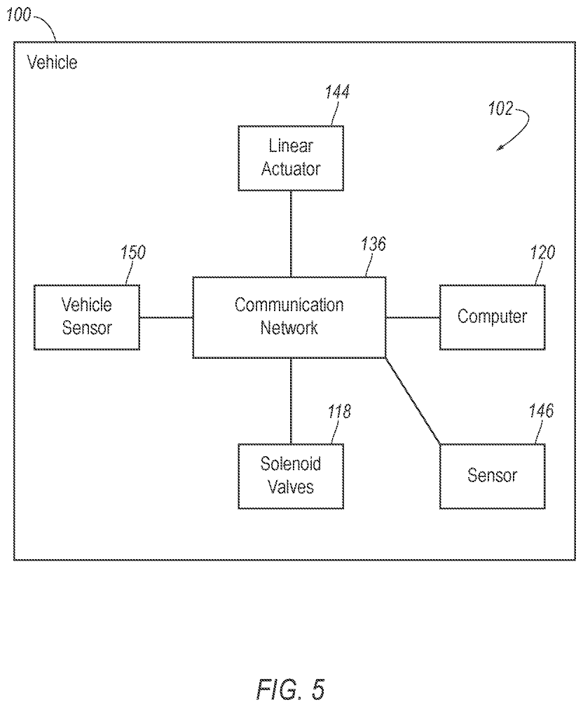

The vehicle 100, illustrated in FIG. 1, may be any suitable type of automobile, e.g., a passenger or commercial automobile such as a sedan, a coupe, a truck, a sport utility vehicle, a crossover vehicle, a van, a minivan, a taxi, a bus, etc. The vehicle 100, for example, may be an autonomous vehicle. In other words, the vehicle 100 may be autonomously operated such that the vehicle 100 may be driven without constant attention from a driver, i.e., the vehicle 100 may be self-driving without human input. For example, a computer 120, illustrated in FIG. 5, can be programmed to operate the vehicle 100 independently of the intervention of a human driver, completely or to a lesser degree. For example, the computer 120 may be programmed to operate the propulsion, brake system, steering, and/or other vehicle systems based at least in part on data received from one or more vehicle sensors 150 (shown in FIG. 4). Vehicle sensors 150 may include Light Detection And Ranging (LIDAR) vehicle sensor(s), etc., disposed on a top of the vehicle, behind a vehicle front windshield, around the vehicle 100, etc., that provide relative locations, sizes, and shapes of objects surrounding the vehicle 100. As another example, one or more radar vehicle sensors fixed to vehicle bumpers may provide data to provide locations of the objects, second vehicles, etc., relative to the location of the vehicle 100. The vehicle sensors 150 may further alternatively or additionally, for example, include camera vehicle sensor(s), e.g. front view, side view, etc., providing images from an area surrounding the vehicle 100.

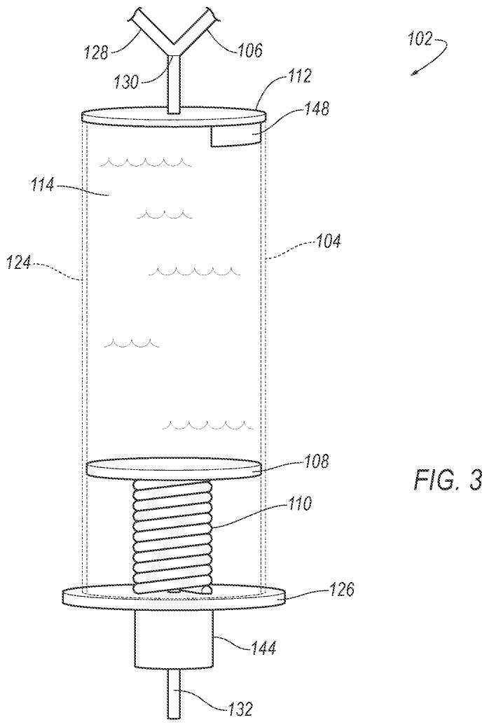

The fluid reservoir 104 stores fluid, e.g., fluid, for cleaning the vehicle sensors 150. The fluid reservoir 104 may store sufficient fluid for cleaning the vehicle sensors 150 for normal operation of the vehicle 100, e.g., such that the amount of stored fluid may be sufficient for multiple cleanings of the vehicle sensors 150 over time. In other words, the amount of stored fluid may be sufficient to the clean the sensors for a typical day, week, etc., of operation of the vehicle 100. For example, when the piston 108 is at a bottom position (shown in FIG. 3 and further discussed below), the working chamber 114 may define a volume of at least one liter. As an example, the volume may be greater than seven liters, e.g., between 7 and 10 liters. The fluid reservoir 104 includes a tank 124, e.g., a hollow cylinder. The fluid reservoir 104 may be metal, plastic, or any suitable material. The fluid reservoir 104 may be elongated between the first end 112 and a second end 126 of the fluid reservoir 104 opposite the first end 112. The fluid reservoir 104 may be support at a rear of the vehicle 100, or any other suitable position.

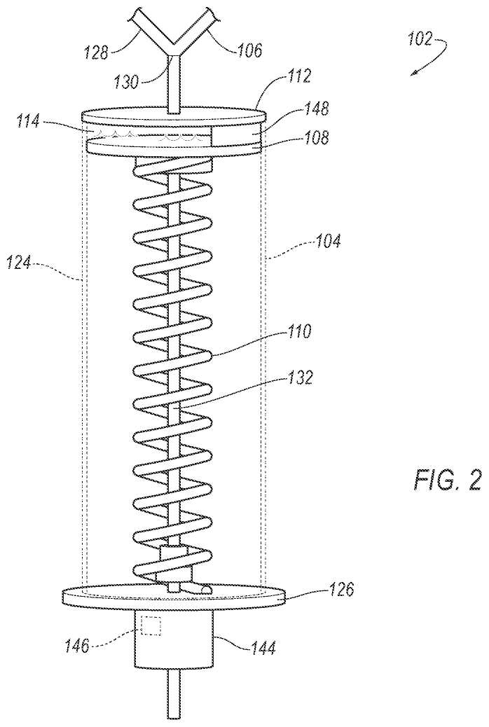

The piston 108 and the fluid reservoir 104 define the working chamber 114, e.g., in the tank 124 between the piston 108 and the first end 112 of the fluid reservoir 104. An outer surface of the piston 108 may be sealed to an inner surface of the tank 124, e.g., to inhibit fluid in the working chamber 114 from flowing past the piston 108 toward the second end 126. The piston 108 is slidably supported in the fluid reservoir 104, e.g., to slide between a top position, illustrated in FIG. 2, and the bottom position, illustrated in FIG. 3. The piston 108 is closer to the first end 112 in the top position than in the bottom position.

A volume of the working chamber 114 is smaller when the piston 108 is at the top position than when the piston 108 is at the bottom position. In other words, moving the piston 108 away from the top position towards the bottom position increases the volume of the working chamber 114, and moving the piston 108 away from the bottom position towards the top position decreases the volume of the working chamber 114.

The fluid reservoir 104 includes the fluid outlet 106 and may include a fluid inlet 128. The working chamber 114 is in fluid communication with the fluid outlet 106 such that fluid may exit the working chamber 114 via the fluid outlet 106. In other words, the fluid outlet 106 of the fluid reservoir 104 provides fluid flow out of the working chamber 114. The working chamber 114 is in fluid communication with the fluid inlet 128 such that fluid may enter the working chamber 114 via the fluid inlet 128. In other words, the fluid inlet 128 provides fluid flow into the working chamber 114. For example, a Y-shaped (or T-shaped) fluid connector 130 may be in fluid communication with the working chamber 114 with one end of the Y-shaped fluid connector 130 connected to the working chamber 114 at the first end 112 of the fluid reservoir 104. The fluid inlet 128 and the fluid outlet 106 may be at the other two ends of the Y-shaped fluid connector 130, respectively. As another example, the fluid reservoir 104 may include a pair of openings separately connected to the working chamber 114 at the first end 112, e.g., with the fluid inlet 128 at one of such openings and the fluid outlet 106 at the other of such openings (not shown). Flow of fluid out of the working chamber 114 may be concurrent with a reduction of the volume of the working chamber 114 and moment of the piston 108 toward the top position. Flow of fluid into the working chamber 114 may be concurrent with an increase of the volume of the working chamber 114 and moment of the piston 108 toward the bottom position.

The fluid reservoir 104 may include a stopper 148. The stopper 148 limits movement of the piston 108. The stopper 148 may by in the working chamber 114 between the first end 112 of the fluid reservoir 104 and the piston 108, e.g., fixed to the inside surface of the tank 124. The piston 108 in the top position may abut the stopper 148.

A rod 132 may be fixed to the piston 108, i.e., such that movement of the rod 132 causes movement of the piston 108 and vice versa. For example, the rod 132 may be fixed via fastener, weld, or other suitable structure. The rod 132 and the piston 108 may be unitary, i.e., a single, uniform piece of material with no seams, joints, fasteners, or adhesives holding it together. In such an example, the rod 132 and the piston 108 are formed together simultaneously as a single continuous unit, e.g., by machining from a unitary blank, molding, forging, casting, etc. Non-unitary components, in contrast, are formed separately and subsequently assembled, e.g., by threaded engagement, welding, etc. The rod 132 may extend outside the fluid reservoir 104. For example, the rod 132 may extend from the piston 108 and away from the first end 112 to beyond the second end 126. The second end 126 may include an opening through which the rod 132 extends.

The spring 110 urges the piston 108 toward the first end 112 of the fluid reservoir 104. In other words, the spring 110 applies force to the piston 108 in a direction away from the second end 126 and toward the first end 112. For example, the spring 110 may urge the piston 108 toward the top position. The spring 110 may be a coil spring, or any suitable type. The spring 110 may be spring steel, or any suitable material.

The spring 110 may be compressed between the second end 126 of the fluid reservoir 104 and the piston 108, e.g., at the top position, the bottom position, and all positions therebetween. In other words, the spring 110 may apply force urging the piston 108 and the second end 126 away from each other, and the piston 108 and the second end 126 may apply reactive force compressing the spring, e.g., regardless of the position of the piston 108 relative to the fluid reservoir 104. The spring 110 may be in the fluid reservoir 104, e.g., in the tank 124. The spring 110 may surround the rod 132, e.g., about an axis that extends from the first end 112 to the second end 126. For example, the spring 110 and the rod 132 may be co-axial with each other. the spring 110 and the rod 132 may be in the tank 124 between the second end 126 and the piston 108

With reference to FIG. 4, The fluid cleaning assembly 102 may include one or more nozzles 116. The nozzles 116 provides washing fluid to maintain clear fields of view of the vehicle sensors 150. For example, nozzles 116 may point at the vehicle sensors 150, e.g., such that fluid flowing out of the nozzles 116 is directed at the vehicle sensors 150 or a surface in front of the vehicle sensors 150, such as a lens or other protective covering. The nozzles 116 may be supported by a roof of the vehicle 100, a hood of the vehicle 100, or at any other suitable location on the vehicle 100.

Each of the nozzles 116 may be in fluid communication with the working chamber 114, i.e., such that fluid may flow from the working chamber 114 to the nozzles 116, e.g., via the fluid outlet 106. For example, a fluid rail 134 may be connect the to the fluid outlet 106 to the nozzles 166 such that fluid may flow therebetween. The fluid rail 134 may include tubing, an inlet, and a plurality of outlets. The fluid outlet 106 of the fluid reservoir 104 may be connected to the fluid inlet of the fluid rail 134. Each outlet of the fluid rail 134 may be connected to the one or more of the nozzles 116.

The fluid cleaning assembly 102 includes one or more valves 118. The valves 118, for example, may be solenoid valves. The valves 118 control fluid flow from the fluid reservoir 104 to one or more of the nozzles 116. Each valve 118 may move between an open position in which fluid flow is permitted and a closed position in which fluid flow is inhibited. Each valve 118 may include an electromagnetic coil, spring, ferromagnetic core, and/or other structure. Each valve 118 may move to the open position or the closed position is response to a command from the computer 120. Each valve 118 may be in communication with the computer 120, e.g., via a communication network 136.

Each valve 118 may be between the one or more of the nozzles 116 and the fluid outlet 106 of the fluid reservoir 104, i.e., such that fluid may flow from the fluid reservoir 104 to certain of the nozzles 116 when the respective valve 118 is in the open position and the fluid may be inhibited from flowing from the fluid reservoir 104 to such nozzles 116 when the respective valve 118 is in the closed position. Valves may be between each of the nozzles 116 and the fluid outlet 106 of the fluid reservoir 104. For example, the valve 118 may be at the outlets of the fluid rail 134 between the fluid rail 134 and the nozzles 116. In other words, the fluid rail 134 may be between the fluid outlet 106 of fluid reservoir 104 and the valves 118.

The fluid cleaning assembly 102 may include a fill port 138. The fill port 138 enables fluid to be added to the fluid cleaning system, e.g., by a human from a jug containing washer fluid, from a fill tube separate from the vehicle 100, etc. For example, the fill port 138 may define an opening that is open to an environment surrounding the vehicle 100. Fluid may be provided to the fill port 138 via the opening. The fill port 138 may include, and the opening may be covered by, a removable cap or the like. The fill port 138 may by in fluid communication with the fluid inlet 128, i.e., such that fluid provided to the fill port 138 can flow to the fluid reservoir 104. For example, tubing may connect the fill port 138 to the fluid inlet 128 of the fluid reservoir 104. The fill port 138 may be directly connected to the fluid reservoir 104, i.e., such that fluid cleaning assembly 102 is free of a second fluid reservoir between the fluid reservoir 104 and the fill port 138.

The fluid cleaning assembly 102 may include one or more check valves 140, 142 to control fluid flow into and/or out of the working chamber 114. Each of the check valves 140, 142 allows fluid flow in one direction and inhibits fluid flow in an opposite direction. For example, the check valves 140, 142 may be ball check valves, diaphragm check valves, swing check valves, lift-check valves, etc.

A first check valve 140 may be between the fluid outlet 106 of the fluid reservoir 104 and the valves 118, e.g., between the fluid reservoir 104 and the fluid rail 134. The first check valve 140 may be oriented to permit fluid flow from the working chamber 114 to the valves 118 and to inhibit fluid flow from the valves 118 to the working chamber 114. For example, higher fluid pressure at a fluid reservoir side of the first check valve 140 than at a solenoid side of the first check valve 140 may cause the first check valve 140 to open, and lower fluid pressure at the fluid reservoir 104 side of the first check valve 140 than at the solenoid side of the first check valve 140 may cause the first check valve 140 to close.

A second check valve 142 may be connected to the fluid inlet 128 of the fluid reservoir 104, e.g., between the fluid inlet 128 and the fill port 138. The second check valve 142 may be oriented to permit fluid flow into the working chamber 114 via the fluid inlet 128 and to inhibit fluid flow out of the working chamber 114 via the fluid inlet 128. For example, higher fluid pressure at a fill port side of the second check valve 142 than at a fluid reservoir side of the second check valve 142 may cause the second check valve 142 to open, and lower fluid pressure at the fill port 138 side of the second check valve 142 than at the fluid reservoir 104 side of the second check valve 142 may cause the second check valve 142 to close.

With reference to FIGS. 2, 3 and 5, the fluid cleaning assembly 102 may include a linear actuator 144, i.e., that generates force, e.g., in response to a command from the computer 120. The linear actuator 144 may be an electro-mechanical actuator, a pneumatic actuator, a piezoelectric actuator, a hydraulic actuator, or any suitable type. The linear actuator 144 may convert rotary motion of an electric motor into linear displacement via screws and/or gears, e.g., with leadscrews, screw jacks, ball screws, roller screws, a rack and pinion, etc. The linear actuator 144 connects to the piston 108 and is configured to move the piston 108 away from the first end 112 of the fluid reservoir 104. The other words, the linear actuator 144 may move the piston 108 away from the top position and toward the bottom position. For example, the rod 132 may be a component of the linear actuator 144 and include a helical thread or rack. A motor of the linear actuator 144 may be coupled to a gear that engages the thread or rack such that rotation of the gear from torque of the motor moves the rod 132 and piston 108 relative to the fluid reservoir 104. Other structures may be used to operatively couple the linear actuator 144 to the piston 108, i.e., such that displacement generated by the linear actuator 144 moves the piston 108. The linear actuator 144 may be in communication with the computer 120, e.g., via the communication network 136. The linear actuator 144 may move the piston 108 relative to the fluid reservoir 104 in response to a command form the computer 120.

The fluid cleaning assembly 102 may include a sensor 146 configured to detect a position of the piston 108 relative to the fluid reservoir 104, e.g., at the top position, the bottom position, or any position therebetween. For example, the sensor 146 may be supported by the fluid reservoir 104 and detect a position of the rod 132 relative to the tank 124 of the fluid reservoir 104. The sensor 146 may detect various indicia on the rod 132. The sensor 146 may be, for example, a capacitive displacement sensor, an eddy-current sensor, a hall effect sensor, an inductive sensor, an optical sensor, a piezo-electric transducer, an ultrasonic sensor, etc. The sensor 146 may be in communication with the computer 120, e.g., via the communication network 136. The sensor 146 may provide data to the computer 120, e.g., via the communication network 136 indicating the position of the piston 108 relative to the fluid reservoir 104. The computer 120 may, for example, use such data to determine the volume of fluid in the working chamber 114.

With reference to FIG. 5, the computer 120 includes a processor and a memory such as are known. The memory includes one or more forms of computer readable media, and stores instructions executable by the computer 120 for performing various operations, including as disclosed herein. The computer 120 may include programming to operate one or more of vehicle brakes, propulsion (e.g., control of acceleration in the vehicle 100 by controlling one or more of an internal combustion engine, electric motor, hybrid engine, etc.), steering, climate control, interior and/or exterior lights, etc., as well as to determine whether and when the computer 120, as opposed to a human operator, is to control such operations. Additionally, the computer 120 may be programmed to determine whether and when a human operator is to control such operations. The computer 120 may be programmed to the perform other operation, the including the operations described herein.

The computer 120 is generally arranged for communications on the communication network 136. The communication network 136 can include a bus in the vehicle 100 such as a controller area network (CAN) or the like, and/or other wired and/or wireless mechanisms. Via the communication network 136, the computer 120 may transmit messages to various devices in the vehicle 100 and/or receive messages (e.g., CAN messages) from the various devices, e.g., the valves 118, the linear actuator 144, the sensor 146, the vehicle sensors 150, an human machine interface (HMI), etc. Alternatively or additionally, in cases where the computer 120 actually comprises a plurality of devices, the communication network 136 may be used for communications between devices represented as the computer 120 in this disclosure.

During operation of the vehicle 100 the valves 118 are all in the closed position and the piston 108 is at the bottom position or between the top position and the bottom position with fluid in the working chamber 114 and the fluid rail 134. The piston 108, urged toward the top position by the spring 110, pressurizes the fluid in the working chamber 114 and the fluid rail 134. The computer 120, e.g., upon detecting a lens or the like in front of one of the vehicle sensors 150 is contaminated, may actuate the valve 118 connected to the nozzle 116 pointed at such sensor 146 to the open position. Pressurized fluid from the fluid rail 134 may flow through the valve 118 in the open position and out of the nozzle 116 toward the sensor 146.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1. An assembly, comprising:
a fluid reservoir having a fluid outlet;
a piston slidably supported in the fluid reservoir;
a spring urging the piston toward an end of the fluid reservoir;
the piston and the fluid reservoir defining a working chamber in fluid communication with the fluid outlet;
a nozzle in fluid communication with the working chamber via the fluid outlet; and
a valve between the nozzle and the fluid outlet.

2. The assembly of claim 1, further comprising a check valve between the fluid outlet and the valve, the check valve oriented to permit fluid flow from the working chamber to the valve, and to inhibit fluid flow from the valve to the working chamber.

3. The assembly of claim 1, further comprising a linear actuator connected to the piston and configured to move the piston away from the end of the fluid reservoir.

4. The assembly of claim 1, further comprising a sensor configured to detect a position of the piston relative to the fluid reservoir.

5. The assembly of claim 1, wherein the fluid reservoir includes a fluid inlet in fluid communication with the working chamber.

6. The assembly of claim 5, further comprising a check valve connected to the fluid inlet and oriented to permit fluid flow into the working chamber via the fluid inlet and to inhibit fluid flow out of the working chamber via the fluid inlet.

7. The assembly of claim 5, further comprising a fill port in fluid communication with the fluid inlet.

8. The assembly of claim 7, wherein the assembly is free of a second fluid reservoir between the fluid reservoir and the fill port.

9. The assembly of claim 1, further comprising a second nozzle in fluid communication with the working chamber via the fluid outlet and a second valve between the second nozzle and the fluid outlet.

10. The assembly of claim 9, further comprising a fluid rail between the fluid outlet and the valve and second valve.

11. The assembly of claim 1, further comprising a stopper in the working chamber between the end of the fluid reservoir and the piston.

12. The assembly of claim 1, wherein the spring is in the fluid reservoir.

13. The assembly of claim 12, wherein the spring is compressed between the piston and a second end of the fluid reservoir opposite the end.

14. The assembly of claim 1, further comprising a rod fixed to the piston and extending outside the fluid reservoir.

15. The assembly of claim 14, wherein the spring surrounds the rod.

16. The assembly of claim 1, further comprising a vehicle sensor, the nozzle pointed at the vehicle sensor.
